(19) United States
(12) Patent Application Publication
(10) Pub. No.: US 2012/0287133 A1
(43) Pub. Date: Nov. 15, 2012

(54) IMAGE PROCESSING APPARATUS AND IMAGE PROCESSING METHOD

(76) Inventors: An-Shih Lee, Hsin-Chu Hsien (TW); Cheng-Lin Wu, Kaohsiung City (TW); Chin-Shuen Li, Taoyuan County (TW)

(21) Appl. No.: 13/469,096

(22) Filed: May 11, 2012

(30) Foreign Application Priority Data
May 11, 2011 (TW) 100116469

(51) Int. Cl. G06T 17/00

(52) U.S. Cl. 345/428

(57) ABSTRACT

An image processing apparatus includes a first timing generator, a second timing generator and an image adjusting unit. The first timing generator is utilized for generating a plurality of first driving signals, where the first driving signals are utilized to define a position of a first window. The second timing generator utilizes its own hardware to generate a plurality of second driving signals without utilizing software, where the second driving signals are utilized to define a position of a second window, and the second window is within the first window. The image adjusting unit is utilized for adjusting image data to generate adjusted image data according to the first driving signals and the second driving signals.

### BACKGROUND OF THE INVENTION

1. Field of the Invention

The present invention relates to an image processing apparatus, and more particularly, to an image processing apparatus which can perform different image processing operations upon image data within two different windows on a screen.

2. Description of the Prior Art

A digital display generally performs same image processing operations upon all image data to generate adjusted image data to be displayed. However, under a condition such as showing display quality of a display having new techniques in an exhibition, the digital display requires to show two windows simultaneously to represent two different display qualities. In addition, in a special design shown in FIG. 1, a window A shows image frame data from a single source, and a window B shows a portion of the image frame data. The window B is within the window A, and a display region of the window B is changed over time. In addition, a next position the window B moves to is calculated by software.

However, if the two windows shown in FIG. 1 are processed and displayed by the software, the image processing chip must be designed to support a Picture In Picture (PIP) function, and within the image processing chip two channels are used to process image data corresponding to two different windows, respectively, to make the image data of the two windows have different display qualities. However, this processing method has following disadvantages:

(1) A longer computing time is required when the next position of the window B is calculated by using software.

(2) Because the operating system of the digital display is very complex, when the system resource or ability is limited, the software may give a priority to other operations rather than calculating the next position of the window B, causing that the moving window B is displayed intermittently.

(3) Because the above-mentioned two windows have different display qualities, the image data corresponding to each of the two windows is processed by using a channel, and the outputs of the two channels are combined to generate the adjusted image data. Therefore, because the two channels are used simultaneously, the related circuits supporting the PIP function also needs to be used. That is, when the system enables the above-mentioned two windows function, the PIP windows must be disabled (note: image data displayed on the PIP windows are from different sources).

### SUMMARY OF THE INVENTION

It is therefore an objective of the present invention to provide an image processing apparatus and associated method, which uses hardware to calculate a next position of a window, to solve the above-mentioned problem.

According to one embodiment of the present invention, an image processing apparatus comprises a first timing generator, a second timing generator and an image adjusting unit. The first timing generator is utilized for generating a plurality of first driving signals, where the first driving signals are utilized to define a position of a first window. The second timing generator is utilized for generating a plurality of second driving signals, where the second driving signals are utilized to define a position of a second window, and the second window is within the first window. The image adjusting unit is coupled to the first timing generator and the second timing generator, and is utilized for adjusting image data to generate adjusted image data according to the first driving signals and the second driving signals. In addition, the second timing generator utilizes its own hardware to generate the second driving signals without utilizing software.

According to another embodiment of the present invention, an image processing method comprises: generating a plurality of first driving signals, wherein the first driving signals are utilized to define a position of a first window; utilizing a timing generator to generate a plurality of second driving signals, wherein the second driving signals are utilized to define a position of a second window, and the second window is within the first window; and adjusting image data to generate adjusted image data according to the first driving signals and the second driving signals, where the timing generator utilizes its own hardware to generate the second driving signals without utilizing software.

According to another embodiment of the present invention, an image processing apparatus comprises a first timing generator, a second timing generator and an image adjusting unit. The first timing generator is utilized for generating a plurality of first driving signals, where the first driving signals are utilized to define a position of a first window. The second timing generator is utilized for generating a plurality of second driving signals, where the second driving signals are utilized to define a position of a second window, and the second window is within the first window. The image adjusting unit is coupled to the first timing generator and the second timing generator, and is utilized for adjusting image data to generate adjusted image data according to the first driving signals and the second driving signals. In addition, the image data comprises at least first image data and second image data, the first image data corresponds to the first window and the second image data corresponds to the second window, and the image adjusting unit utilizes a same circuit to adjust the image data to generate the adjusted image data.

According to another embodiment of the present invention, an image processing method comprises: generating a plurality of first driving signals, wherein the first driving signals are utilized to define a position of a first window; generating a plurality of second driving signals, wherein the second driving signals are utilized to define a position of a second window, and the second window is within the first window; and utilizing a same circuit to adjust image data to generate adjusted image data according to the first driving signals and the second driving signals, wherein the image data comprises at least first image data and second image data, the first image data corresponds to the first window and the second image data corresponds to the second window.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating that two windows are displayed on a screen.

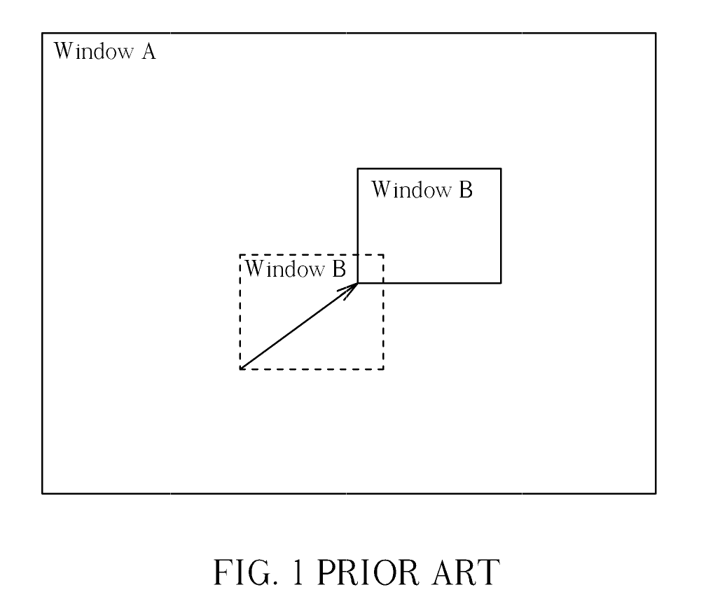

FIG. 2A is a diagram illustrating an image processing apparatus according to one embodiment of the present invention.

FIG. 2B is a diagram illustrating an image adjusting unit shown in FIG. 2A according to one embodiment of the present invention.

FIG. 3 is a diagram illustrating a first window and a second window on the screen.

FIG. 4 is a diagram illustrating a second timing generator shown in FIG. 2A according to one embodiment of the present invention.

FIG. 5 is a diagram illustrating initial parameters and starting points of the first window and the second window on the screen.

FIG. 6 is a flowchart of a method for determining a position of the second window.

FIG. 7 is a diagram illustrating that the second window moves under a normal moving condition.

FIG. 8 is a diagram illustrating that the second window aligns a boundary.

FIG. 9 is a diagram illustrating that the second window moves under a boundary-triggered condition.

### DETAILED DESCRIPTION

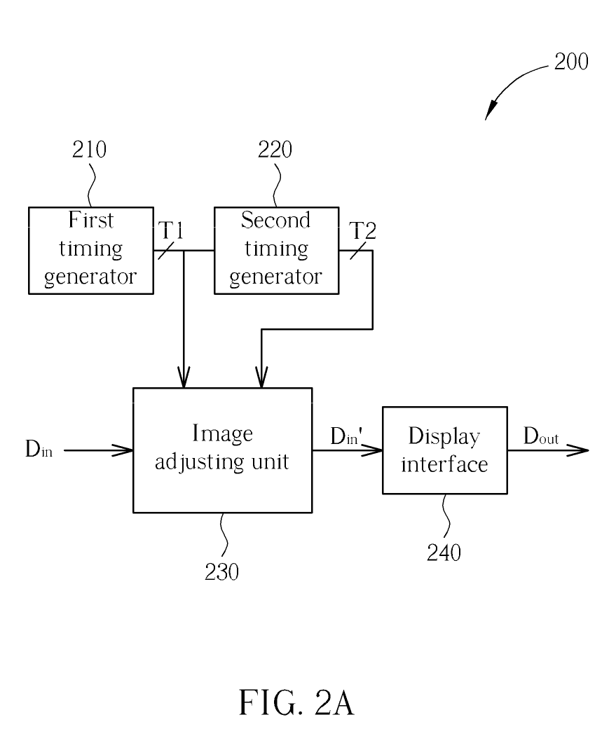

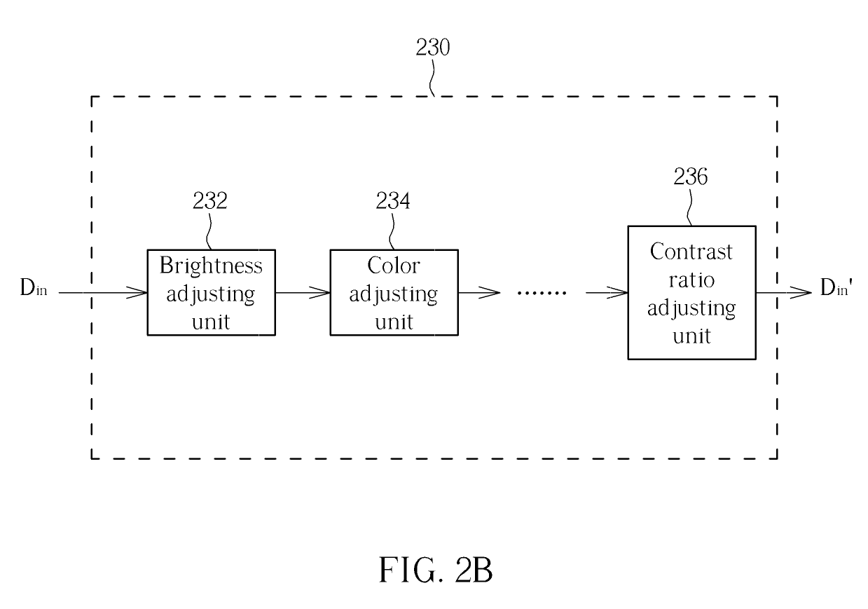

Please refer to FIG. 2A, which illustrates an image processing apparatus 200 according to one embodiment of the present invention. As shown in FIG. 2A, the image processing apparatus 200 includes a first timing generator 210, a second timing generator 220, an image adjusting unit 230 and a display interface 240. The image processing apparatus 200 can be applied to televisions, personal computers, digital cameras or any other electronic devices having screens.

In the operations of the image processing apparatus 200, the first timing generator 210 generates a plurality of first driving signals T1 to define a position of a first window. In this embodiment, the first window includes a whole display region of a screen of a display, and the plurality of driving signals T1 comprise a horizontal synchronization signal Hsync1, a vertical synchronization signal Vsync1, data enable signal DE1, start point information ST1, information of a width of the first window and information of a length of the first window.

Then, the second timing generator 220 uses its own hardware to generate a plurality of second driving signals T2 to define a position of a second window according to at least a portion of the first driving signals T1, where the second window is within the first window, and the plurality of second driving signals T2 comprise a horizontal synchronization signal Hsync2, a vertical synchronization signal Vsync2, data enable signal DE2, start point information ST2, information of a width of the second window and information of a length of the second window. In addition, the second driving signals T2 are generated without using any software/program code.

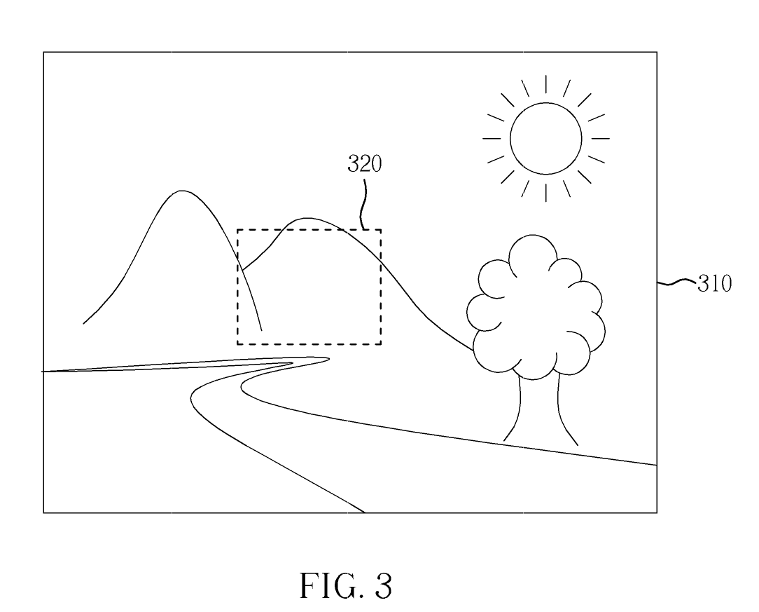

Then, the image adjusting unit 230 adjusts image data Din to generate adjusted image data Din′ according to the first driving signals and the second driving signals, where first image data and second image data of the image data Din, respectively corresponding to the first window and the second window, are adjusted by different image processing operations. For example, referring to FIG. 3, assuming that the image data Din is an image frame data, the image adjusting unit 230 performs different image processing operations upon the first image data within the first window 310 (i.e., all the region outside the second window 320 shown in FIG. 3) and the second image data within the second window 320, where the “different image processing operations” comprise brightness adjustment, color adjustment, contrast ratio adjustment, sharpness adjustment or any other image adjustment.

Finally, the display interface 240 receives the adjusted image data Din′ to generate output image data Dout to be displayed on the display.

In addition, the image adjusting unit 230 uses the same circuit to process the first image data corresponding to the first window 310 and the second image data corresponding to the second window 320 of the image data Din. That is, the image data Din does not need to be processed by two different circuits (i.e., the prior art two different channels) to generate the adjusted image data Din′. In detail, please refer to FIG. 2B which is a diagram illustrating the image adjusting unit 230 according to one embodiment of the present invention, the image adjusting unit 230 includes a brightness adjusting unit 232, a color adjusting unit 234 and a contrast ratio adjusting unit 236. It is noted that the adjusting units included in the image adjusting unit 230 are for illustrative purposes only, and are not meant to be a limitation of the present invention. In the operations of the image adjusting unit 230, the image frame data Din is inputted into the brightness adjusting unit 232 line-by-line, and at least one of the brightness adjusting unit 232, color adjusting unit 234 and contrast ratio adjusting unit 236 performs different operations upon the first image data corresponding to the first window 310 and the second image data corresponding to the second window 320. For example, when the brightness adjusting unit 232 receives the first image data corresponding the first window 310, the brightness adjusting unit 232 performs a first image adjusting operation upon the first image data; and when the brightness adjusting unit 232 receives the second image data corresponding the second window 320, the brightness adjusting unit 232 may perform a second image adjusting operation, different from the first image adjusting operation, upon the first image data, or the brightness adjusting unit 232 may not perform any operation upon the second image data and directly bypass the second image data (i.e., the second image data is sent to the color adjusting unit 234 without processed by the brightness adjusting unit 232).

It is noted that the image data Din of the above embodiment is a single image frame data from a single source as shown in FIG. 3. In other embodiments, however, the image data Din may be from more than one source. For example, the content of the second window 320 can be another picture; or a portion of first window 310 is used to show the PIP image. These alternative designs shall fall within the scope of the present invention.

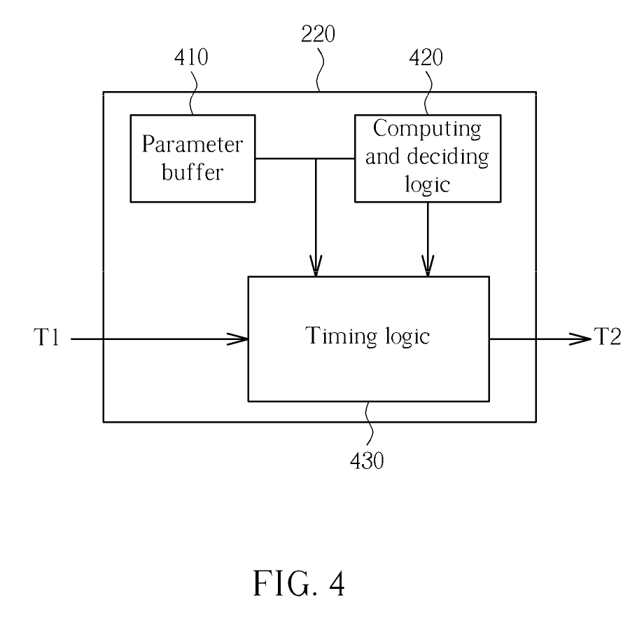

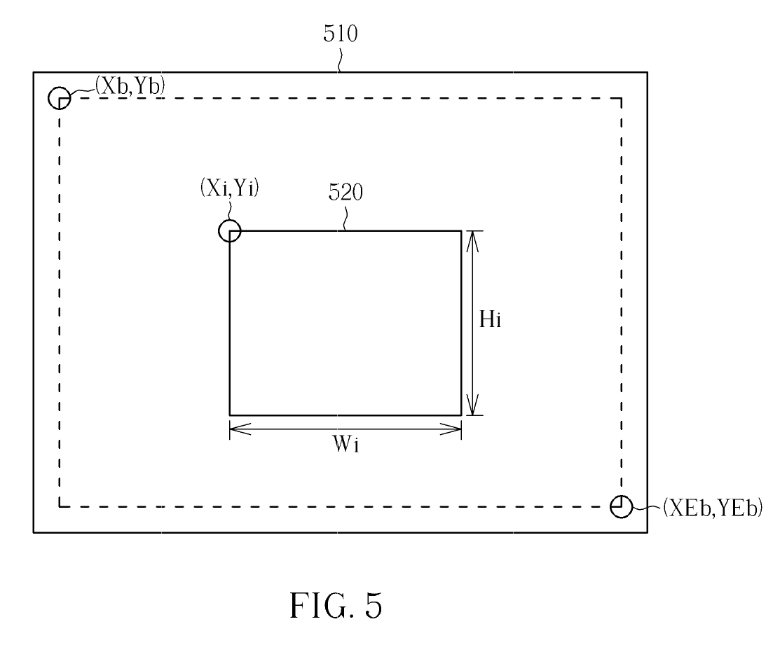

Please refer to FIG. 4, which illustrates the second timing generator 220 according to one embodiment of the present invention. As shown in FIG. 4, the second timing generator 220 includes a parameter buffer 410, a computing and deciding logic 420 and a timing logic 430. The parameter buffer 410 stores the following initial parameters: horizontal starting point of the second window Xi, vertical starting point of the second window Yi, width of the second window Wi, height of the second window Hi, horizontal starting point of the region capable of showing the second window Xb, vertical starting point of the region capable of showing the second window Yb, horizontal end point of the region capable of showing the second window XEb, vertical end point of the region capable of showing the second window YEb, minimum width of the second window Wmin, minimum height of the second window Hmin, horizontal increment/decrement of the starting point of the second window ΔX, vertical increment/decrement of the starting point of the second window ΔY, increment/decrement of the width of the second window ΔW, and increment/decrement of the height of the second window ΔH, where ΔX, ΔY, ΔW and ΔH can be positive or negative. In addition, the parameter buffer 410 further includes four parameters: Yinv_L, Yinv_R, Xinv_U and Xinv_D, which are used to represent that whether the parameter ΔX or ΔY needs to change its sign when the left side, right side, upper side and lower side boundary conditions are triggered, respectively. FIG. 5 is a diagram illustrating the initial parameters and the starting points of the first window and the second window displayed on a screen.

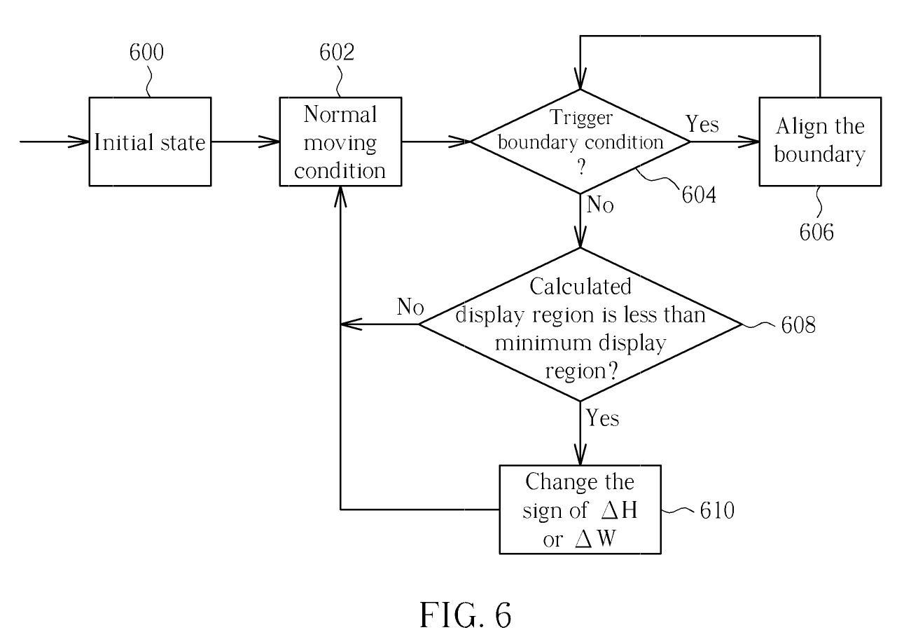

In the operations of the second timing generator 220, please refer to FIG. 4 and FIG. 6 together. FIG. 6 is a flow chart of a method for determining the position of the second window according to one embodiment of the present invention. Referring to FIG. 6, the flow is described as follows.

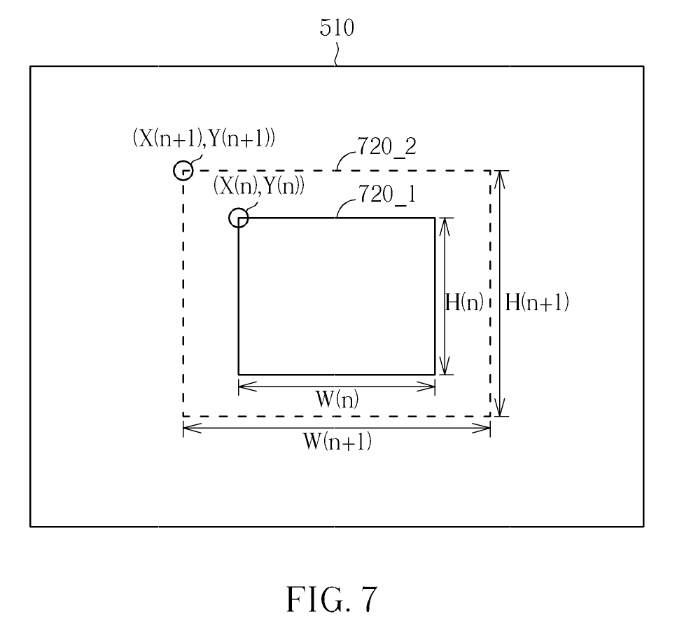

In Step 600, the second timing generator is under an initial state, that is the screen shows the image of FIG. 5. Then, in Step 602, the computing and deciding logic 420 updates the position and the size of the second window to generate an updated position and size of the second window. The timing logic 430 then receives the information from the parameter buffer 410 and the computing and deciding logic 420 to generate the plurality of second driving signals T2 to the display interface 240. For example, please refer to FIG. 7, assuming that at a current time “n” the second window 720_1 has the start point (X(n), Y(n)), and the width and height of the second window 720_1 are W(n) and H(n), respectively, the computing and deciding logic 420 uses the following formula to calculate the start point (X(n+1), Y(n+1)), the width W(n+1) and the height H(n+1) of the second window 720_1 at a next time (n+1):

X(n+1)=X(n)+ΔX;

Y(n+1)=Y(n)+ΔY;

W(n+1)=W(n)+ΔW;

H(n+1)=H(n)+ΔH.

In Step 604, the computing and deciding logic 420 determines if the display region of the second window exceeds the region capable of showing the second window (i.e., determine if the display region of the second window exceeds the region limited by Xb, Yb, XEb and YEb). If the display region of the second window exceeds the region capable of showing the second window, the flow enters Step 606.

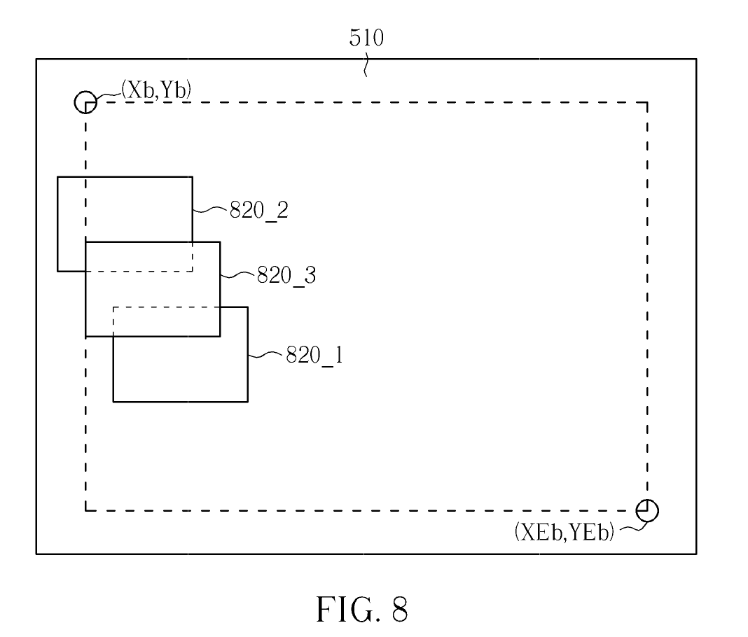

In Step 606, the computing and deciding logic 420 uses the current position and the next position of the second window to update the next position of the second window so as to make the second window to align the boundary. Please refer to FIG. 8, FIG. 8 shows the current time second window 820_1 and the next time second window 820_2 that is calculated in Step 602. Because the next time second window 820_2 exceeds the region capable of showing the second window, the computing and deciding logic 420 will calculate a second window 820_3 according to the positions of the second windows 802_1 and 802_2, where the second window 820_3 aligns the boundary of the region capable of showing the second window. In addition, although FIG. 8 merely shows that the second window aligns the left boundary, a person skilled in this art should understand how to make the second window to align the other three boundaries, further descriptions are therefore omitted here.

Then, after the computing and deciding logic 420 calculates the second window 820_3, the computing and deciding logic 420 will change the signs of ΔW and ΔH, and will determine whether to change the signs of ΔX and ΔY or not according to the triggered boundary condition, where these determinations refer to the parameters Yinv_L, Yinv_R, Xinv_U and Xinv_D stored in the parameter buffer 410. The parameters are set as follows:

Yinv_L: Yinv_L is used to determine whether to change the sign of ΔY or not when the left boundary is triggered; “+1” represents “not change the sign” and “−1” represents “change the sign”.

Yinv_R: Yinv_R is used to determine whether to change the sign of ΔY or not when the right boundary is triggered; “+1” represents “not change the sign” and “−1” represents “change the sign”.

Xinv_U: Xinv_U is used to determine whether to change the sign of ΔX or not when the upper boundary is triggered; “+1” represents “not change the sign” and “−1” represents “change the sign”.

Xinv_D: Xinv_D is used to determine whether to change the sign of ΔX or not when the lower boundary is triggered; “+1” represents “not change the sign” and “−1” represents “change the sign”.

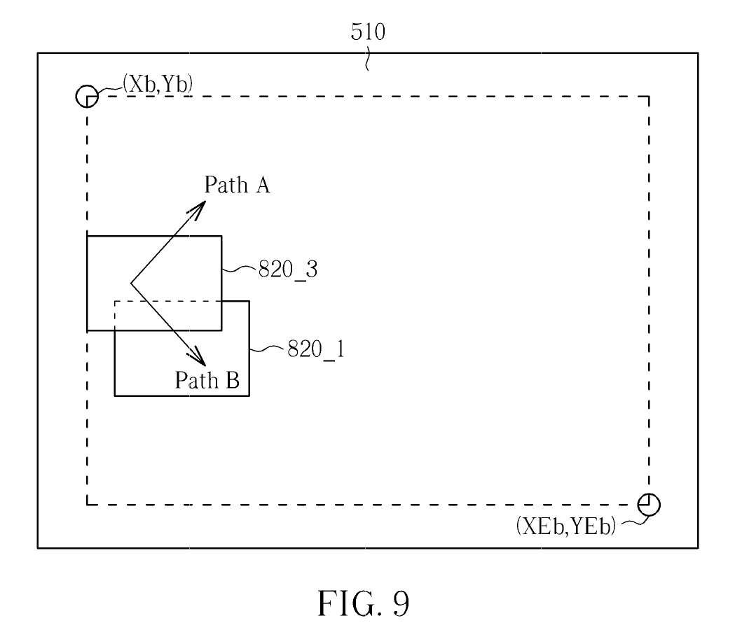

For example, please refer to FIG. 9, when the second window 802_1 moves left to become the second window 820_3, the left boundary condition is triggered, and the computing and deciding logic 420 determines the path (path A or path B shown in FIG. 9) the second window moves along, where:

Path A: Yinv_L=+1;

Path B: Yinv_L=+1.

In addition, although FIG. 9 merely shows triggering the left boundary condition, a person skilled in this art should understand the operations of the computing and deciding logic 420 when the other three boundary conditions are triggered, further descriptions are therefore omitted here.

In Step 608, the computing and deciding logic 420 determines if the calculated display region of the second window is less than a minimum display region of the second window (i.e., determine whether the width of the second window is less than the minimum width Wmin or not, and determine whether the height of the second window is less than the minimum width Hmin or not). If the calculated display region of the second window is less than the minimum display region of the second window, the flow enters Step 610.

In Step 610, when the width of the second window calculated by the computing and deciding logic 420 is less than Wmin, the computing and deciding logic 420 will change the sign of ΔW. That is, if the original ΔW is a negative value, the computing and deciding logic 420 changes the original ΔW to be a positive value, and uses the changed ΔW to calculate an updated width of the second window. Similarly, when the height of the second window calculated by the computing and deciding logic 420 is less than Hmin, the computing and deciding logic 420 will change the sign of ΔH. That is, if the original ΔH is a negative value, the computing and deciding logic 420 changes the original ΔH to be a positive value, and uses the changed ΔH to calculate an updated height of the second window.

Briefly summarized, in the image processing apparatus and associated method, the first timing generator and the second timing generator are used to generate the plurality of first driving signals and second driving signals to define positions of the first window and the second window, respectively, where the second driving signals are generated by hardware of the second timing generator without using software. The image adjusting unit performs different image processing operations upon the first image data corresponding to the first window and the second image data corresponding to the second window. Therefore, the calculation of the position of the second window will not be influenced by the other operations of the system, and the calculation of the second timing generator is less complex than the calculation processed by software. In addition, because the operations of the image processing apparatus does not need to occupy the PIP hardware, the two-windows function of the present invention and the PIP function can be simultaneously enabled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing apparatus, comprising:
a first timing generator, for generating a plurality of first driving signals, wherein the first driving signals are utilized to define a position of a first window;
a second timing generator, for generating a plurality of second driving signals, wherein the second driving signals are utilized to define a position of a second window, and the second window is within the first window; and
an image adjusting unit, coupled to the first timing generator and the second timing generator, for adjusting image data to generate adjusted image data according to the first driving signals and the second driving signals;
wherein the second timing generator utilizes its own hardware to generate the second driving signals without utilizing software.

2. The image processing apparatus of claim 1, wherein the image data comprises at least first image data and second image data, the first image data corresponds to the first window and the second image data corresponds to the second window, and the image adjusting unit performs a first image processing operation and a second image processing operation upon the first image data and the second image data, respectively, to generate the adjusted image data, where the second image processing operation is different from the first image processing operation.

3. The image processing apparatus of claim 2, wherein the image data is image frame data, the first image data is a portion of the image frame data, and the second image data is another portion of the image frame data.

4. The image processing apparatus of claim 1, wherein the second timing generator generates the second driving signals according to at least a portion of the first driving signals.

5. The image processing apparatus of claim 1, wherein the position of the second window is changed over time, and the second timing generator utilizes its own hardware to generate a plurality of updated second driving signals, where the updated second driving signals are utilized to define an updated position of the second window.

6. The image processing apparatus of claim 1, wherein the image data comprises at least first image data and second image data, the first image data corresponds to the first window and the second image data corresponds to the second window, and the image adjusting unit utilizes a same circuit to perform a first image processing operation and a second image processing operation upon the first image data and the second image data, respectively, to generate the adjusted image data, where the second image processing operation is different from the first image processing operation.

7. The image processing apparatus of claim 6, wherein the image data is image frame data, the first image data is a portion of the image frame data, and the second image data is another portion of the image frame data, and pixel data of the image frame data is inputted into the same circuit line-by-line to be processed under the first image processing operation and the second image processing operation.

8. An image processing method, comprising:
generating a plurality of first driving signals, wherein the first driving signals are utilized to define a position of a first window;
utilizing a timing generator to generate a plurality of second driving signals, wherein the second driving signals are utilized to define a position of a second window, and the second window is within the first window; and
adjusting image data to generate adjusted image data according to the first driving signals and the second driving signals;
wherein the timing generator utilizes its own hardware to generate the second driving signals without utilizing software.

9. The method of claim 8, wherein the image data comprises at least first image data and second image data, the first image data corresponds to the first window and the second image data corresponds to the second window, and the step of generating the adjusted image data comprises:
performing a first image processing operation and a second image processing operation upon the first image data and the second image data, respectively, to generate the adjusted image data, wherein the second image processing operation is different from the first image processing operation.

10. The method of claim 9, wherein the image data is image frame data, the first image data is a portion of the image frame data, and the second image data is another portion of the image frame data.

11. The method of claim 8, wherein the step of utilizing the timing generator to generate the second driving signals comprises:
utilizing the timing generator to generate the second driving signals according to the at least a portion of the first driving signals.

12. The method of claim 8, wherein the position of the second window is changed over time, and the method further comprises:
utilizing the timing generator to generate a plurality of updated second driving signals, wherein the updated second driving signals are utilized to define an updated position of the second window.

13. The method of claim 8, wherein the image data comprises at least first image data and second image data, the first image data corresponds to the first window and the second image data corresponds to the second window, and the step of generating the adjusted image data comprises:
utilizing a same circuit to perform a first image processing operation and a second image processing operation upon the first image data and the second image data, respectively, to generate the adjusted image data, where the second image processing operation is different from the first image processing operation.

14. The method of claim 13, wherein the image data is image frame data, the first image data is a portion of the image frame data, and the second image data is another portion of the image frame data, and pixel data of the image frame data is inputted into the same circuit line-by-line to be processed under the first image processing operation and the second image processing operation.

15. An image processing apparatus, comprising:
a first timing generator, for generating a plurality of first driving signals, wherein the first driving signals are utilized to define a position of a first window;
a second timing generator, for generating a plurality of second driving signals, wherein the second driving signals are utilized to define a position of a second window, and the second window is within the first window; and
an image adjusting unit, coupled to the first timing generator and the second timing generator, for adjusting image data to generate adjusted image data according to the first driving signals and the second driving signals;
wherein the image data comprises at least first image data and second image data, the first image data corresponds to the first window and the second image data corresponds to the second window, and the image adjusting unit utilizes a same circuit to adjust the image data to generate the adjusted image data.

16. The image processing apparatus of claim 15, wherein the image data is image frame data, the first image data is a portion of the image frame data, and the second image data is another portion of the image frame data, and pixel data of the image frame data is inputted into the same circuit line-by-line.
